(19) United States
(12) Patent Application Publication
(10) Pub. No.: US 2015/0140166 A1
(43) Pub. Date: May 21, 2015

(54) PROCESS FOR PREPARING A LIQUID FOOD PRODUCT ENRICHED WITH OLIGOSACCHARIDES AND WITH POLYSACCHARIDES

(71) Applicants: LE MATERIEL PERA, Florensac (FR); INSTITUT NATIONAL DE LA RECHERCHE AGRONOMIQUE-INRA, Paris (FR)

(72) Inventors: Jean-Louis Escudier, Armissan (FR); Michel Mikolajczak, Gruissan (FR); Jean-Luc Favarel, Rabastens (FR); Pascale Williams, Montpellier (FR); Thierry Doco, Laverune (FR)

(21) Appl. No.: 14/347,223

(22) PCT Filed: Oct. 1, 2012
(86) PCT No.: PCT/FR2012/052224

§ 371 Date: Mar. 25, 2014

(30) Foreign Application Priority Data
Sep. 30, 2011 (FR) 1158819

(51) Int. Cl. C12G 1/022

(52) U.S. Cl. CPC C12G 1/0203
USPC 426/13; 426/15

(57) ABSTRACT

The subject matter of the invention is a process for preparing a liquid food product enriched with oligosaccharides and with polysaccharides starting from berries, in the absence of alcoholic fermentation in the presence of the berries, which comprises (a) heating the berries at a temperature ranging from 40° C. to 100° C., (b) placing the berries under vacuum at a pressure ranging from 10³ to 3×10⁴ Pa, and (c) a step of maceration of the berries by inoculation of one or more pectolytic enzymes, and extraction of the juice before any fermentative process.

### TECHNICAL FIELD OF THE INVENTION

The invention relates to the field of preparing liquid food products from grape berries and, more particularly, to the field of preparing grape juice and grape musts that are usable during liquid-phase vinification, in the absence of grape berries during the fermentation phase.

### PRIOR ART

Traditional methods for making red wine are based on implementing the following steps: (i) destemming and crushing the grape berries, (ii) alcoholic fermentation and pellicular maceration during tank fermentation, and (iii) running-off and pressing, which produce free-run wine and press wine, respectively.

The fermentation and pellicular maceration step is a key step in the method for making red wine, during which the wine acquires its color intensity and its flavor structure through the diffusion of pigments (anthocyanins) and tannins from the grape berries' skins into the fermentation juice. This step lasts from a few days up to several weeks, and enables the extraction of only, at most, 50% of the initial phenol compounds. Alcohol produced by fermentation makes it possible, during the latter step, to gradually extract the grape berries' qualitative compounds (polyphenol compounds and polysaccharide compounds).

For over thirty years, winemakers have attempted to develop alternative methods to pellicular maceration during fermentation in order to optimize the extraction of polyphenol compounds. These methods are generally implemented prior to alcoholic fermentation of the berries. One such method involves hot maceration of the berries prior to fermentation. This method consists of heating the berries to a temperature of approximately 70° C. for several hours. Another alternative method is the “cell cracking” method, which consists of compressing the grape berries at a pressure ranging from 20 to 60 bars, then releasing the berries at atmospheric pressure. Finally, the “flash release” method has been proposed; it consists of subjecting harvested grapes that have been heated to a temperature of approximately 85° C.-95° C. to an instant vacuum at a pressure of approximately 50-60 absolute mbar. The flash release method, which is described in patent EP0728189 among other documents, has proven to be the method that is most suitable for improving the extraction of the polyphenol compounds originally present in grape skins during the pellicular fermentation on marc phase. At present, this technology is widely used by wineries in both Europe and South America.

A person skilled in the art therefore has access to very effective methods for producing juices and wines with high polyphenol contents and intensity.

Pigments and tannins are often described as the compounds that are responsible for wine's organoleptic qualities. Nevertheless, several studies have shown that other classes of chemical compounds play a significant role in the organoleptic properties of wines. It has been demonstrated that certain polysaccharides (more particularly, rhamnogalacturonan-II or RGII) lower the astringency of tannins. It is also known that oligosaccharides and polysaccharides help to stabilize and maintain the color intensity of wines over time. It has, moreover, been shown that polysaccharides and oligosaccharides derived from pectins have a wide range of pharmacological activity, including immunostimulating, anti metastatic, and cholesterol-lowering properties (Yamada, 1996, Progress in Biotechnology, 14, 173-190). Oligosaccharides also have a beneficial effect on health (Qiang et al., 2009, Carb. Polymers, 77, 435-44). They are classified among the soluble fibers; as such, they appear to facilitate intestinal transit and to activate fermentation in the colon (Elleuch et al., 2011, Food Chemistry, 124, 411-421), but they may play an important role in fruit juices and derived beverages due to their physicochemical properties, such as cation chelation (Cescutti & Rizzo, 2001, Journal of Agricultural and Food Chemistry, 2001, 49, 3262-3267). Despite the direct impact that polysaccharides and oligosaccharides have on the organoleptic properties of wine and grape juice, as well as on health, studies on optimizing their extraction remain limited.

Doco et al. (J. Agr. Food Chem., 2007, 55, 6643-6649) compares the effect of various processing methods used in winemaking that either do or do not involve a thermal processing step. The authors conclude that a combined flash release and enzymatic maceration step, followed by pressing before fermentation during the process, results in decreased total polysaccharides present in the wine, relative to a control that only undergoes a pellicular fermentation step, or relative to a wine produced by performing a flash release step prior to pellicular fermentation.

Therefore, a need currently exists for novel methods enabling the preparation of grape juices and wines enriched with oligosaccharides and polysaccharides that is compatible with liquid-phase fermentation, as is used in the formulation of white wines.

### SUMMARY OF THE INVENTION

The invention relates to a method for preparing a liquid food product enriched with oligosaccharides and polysaccharides from grape berries, including the following successive steps:
(a) a step for heating the berries to a temperature ranging from 40° C. to 100° C.,
(b) a step for placing the berries in a vacuum at a pressure ranging from 10³ to 3.10⁴ Pa; said step for placing the berries in a vacuum is preferably performed immediately after step (a) is completed,
(c) a step for macerating the berries by seeding them with one or more pectolytic enzymes, and
(d) a final step for recovering the liquid food product.
This step for recovering the liquid food product consists of separating the juice from the grape berries (by pressing or centrifugation) before optional fermentation of the juice, if the objective sought is to formulate wine.

An additional object of the invention is the creation of a liquid food product enriched with polysaccharides and oligosaccharides that may be obtained through the invention's preparation method.

A further object of the invention is the creation of a method for preparing a wine, preferably a red wine, characterized in that it includes a liquid-phase vinification of a liquid food product as defined previously, or of a liquid food product obtained according to the method of the invention.

### FIGURE

FIG. 1 shows an installation designed to implement the preparation method of a liquid food product of the invention. The installation includes a device (1) for receiving the harvested grapes (20) that is connected to a destemmer (2). From the destemmer (2), the harvested grapes (20) are conveyed by a suitable means (3) to a drainer (4). The drained juice (21) is recovered after it drips out of the drainer (4). The drained juice may be eliminated or added to the juice that is produced by following the method. The drained berries are heated inside the heating chamber (5) that is connected to a boiler (6). Upon leaving the heating chamber (5), the heated berries are conveyed by a suitable means (16) to the release chamber (7). The release chamber (7) is connected to a condenser (8). The condenser (8) is linked to a cooling tower (11) and to a vacuum pump (9). Means (10) enables recovery of the condensate (22) exiting the condenser (8). In the embodiment shown in FIG. 1, the condensate (22) may be eliminated, and therefore need not be added back into the final product. Upon leaving the release chamber (7), the berries are conveyed by a suitable pipe (14) to the maceration tank (13). The enzymatic preparation with pectolytic activity (12) is added to the berries in the pipe (14) by suitable injection means (11). After a suitable dwell time inside the maceration tank, the processed berries (23) are conveyed to a press (15) via a pipe (17).

### DETAILED DESCRIPTION OF THE INVENTION

The Applicant has conducted long-term research in order to design a liquid-phase vinification method for producing red wine that offers improved organoleptic qualities. The Applicant has researched the production of balanced red wines with high polyphenol content and color intensity. The Applicant has additionally worked to develop a means for increasing the content of oligosaccharides and polysaccharides in wine, since these compounds are known to be involved in wine's organoleptic and nutritional qualities, as well as its health-promoting properties. To the Applicant's knowledge, known liquid-phase vinification methods have generally resulted in the production of red wines with poor polysaccharide and oligosaccharide content levels (lower than those produced when fermentation is performed with skins present).

From this perspective, the Applicant has designed a method for producing grape juice that may, at the same time, be used in liquid-phase vinification and that offer high content levels of polysaccharides and oligosaccharides. This method includes a step for processing the grape berries using flash release coupled with a subsequent step of pre-pressing and prefermentation maceration of the berries in the presence of pectolytic enzymes. The flash release step for the grape berries itself includes two sub-steps, namely, (i) heating the berries over a time period of several minutes at a temperature ranging from 40° C. to 100° C., followed immediately by (ii) placing the heated berries in a vacuum at a pressure ranging generally from 10³ to 3.10⁴ Pa. The instant vacuuming of the heated berries causes partial vaporization of the water contained inside the berries, leading to breakdown of the tissue matrix. This cellular breakdown enables increased extraction of organoleptic compounds.

The Applicant has shown that the subsequent processing of the berries by maceration using pectolytic enzymes enhances the extraction of the polysaccharides and oligosaccharides that are initially present inside the cell walls of the grape berries. The Applicant has also shown that coupling a flash release step with a maceration step using pectolytic enzymes enables the production of grape juice with high polysaccharide and oligosaccharide content levels combined with high levels of polyphenols and color intensity.

Generally speaking, the step involving macerating the berries using pectolytic enzymes is implemented after the flash release step and before any pressing step for separating the juice of the berries from the marc.

Unexpectedly, the Applicant has observed that his method enables the production of grape juice with content levels of oligosaccharides and polysaccharides that are much higher than those of juices produced using traditional extraction methods such as thermal processing or methods implementing only flash release technology (but in the absence of enzymatic maceration before pressing the berries).

Equally unexpectedly, the Applicant has also demonstrated the existence of a synergistic effect resulting from combining flash release of the grape berries with the subsequent step of macerating the grape berries on the content levels of polysaccharides and oligosaccharides in the final juices. This type of synergistic effect is not observed at this level when a traditional step involving thermal processing of the harvested grapes is combined with a subsequent maceration step using pectolytic enzymes.

The coupling of a flash release step with a pre-pressing maceration step using pectolytic enzymes thereby enables the production of grape juices from the Teinturier (Alicante) grape variety with a polysaccharide content that is generally at least 600 mg/L, and more particularly ranges from 600 to 700 mg/L, and an oligosaccharide content that is generally at least 500 mg/L, and more particularly ranges from 500 to 1000 mg/L. Strikingly, the rhamnogalacturonan-II (RGII) polysaccharide content in the final juice ranges from 200 to 300 mg/L, which is much higher than what is generally observed in musts whose RGII content is lower than 50 mg/L. Surprisingly, the RGII content levels for the grape juices produced by the method of the invention are also much higher than those observed in red wines produced through solid-phase vinification (that is, by fermentation maceration on marc), which generally have RGII content levels from 100 to 150 mg/L.

The Applicant is of the opinion that the grape juices obtained by the method described above, which includes a step for flash release of the grape berries followed by a maceration step using pectolytic enzymes, are especially well suited to the preparation of wine by liquid-phase fermentation. Without wishing to be bound to any particular theory, the Applicant believes that, due to their high polysaccharide and oligosaccharide content, the fermentation of the grape juices obtained using the abovementioned method enables the production of wines offering high organoleptic qualities—in particular, with regard to body and mouth feel—combined with improved nutritional qualities.

The Applicant believes that the abovementioned grape juice preparation method—which includes a step for flash release of the berries, followed by their maceration in the presence of pectolytic enzymes—may be used to produce juices enriched with polysaccharides and oligosaccharides from any type of berries other than grape berries, since the skin of the berries is largely composed of pectin. All grape berries may therefore be suitable for the implementation of the method of the present invention: more particularly, red grape berries, enabling the production of red wine.

The invention thus relates to a method for preparing a liquid food product enriched in oligosaccharides and polysaccharides from berries.

As defined by the invention, “polysaccharide” is understood to mean a linear or branched polymer including at least 11 glycosidic residues linked together by glycosidic bonds.

As defined by the invention, “oligosaccharide” is understood to mean a molecule including a chain of 2 to 10 glycosidic residues linked together by glycosidic bonds.

The polysaccharide fractions of red wines and of grape juices generally include arabinose- and galactose-rich polysaccharides (AGRP) and rhamnogalacturonans (RGI and RGII). The oligosaccharide fractions of red wines and of grape juices, for their part, generally include oligosaccharides made up of sugars selected from rhamnose, galactose, xylose, glucuronic acid, and galacturonic acid.

In the context of the present invention, a liquid food product enriched with oligosaccharides and polysaccharides means that the food product obtained upon completion of the method of the invention has:
A polysaccharide content at least equal to 1.2 times, preferably at least equal to 1.5 times, the polysaccharide content of a reference liquid food product obtained on a single grade of berry by a method similar to that of the invention but that does not contain the enzymatic maceration step (c) and
An oligosaccharide content at least equal to 1.2 times, preferably at least equal to 1.5 times, the oligosaccharide content of a liquid food product obtained by a method similar to that of the invention but that does not contain the enzymatic maceration step (c).

A first content that is at least equal to 1.2 times the second content encompasses a content that is at least equal to 1.4, 1.6, 1.8, 2.0, 2.2, 2.4, 2.6, 2.8, and 3.0 times the second content.

The reference liquid food product is the product obtained:
(i) From_{[A1]} a first material that is identical to the one used to obtain the food product of the invention and
(ii) By implementing all of the steps leading to obtaining the food product of the invention except for the enzymatic maceration step (c).

The polysaccharide and oligosaccharide contents of the liquid food product may be obtained using methods known to a person skilled in the art. As is illustrated in the examples, the polysaccharide content of the liquid food product may be determined using the method described by Vidal et al. (Carbohydrate Polymers, 2003, 54, 1, 439-447). This method is based on GC/MS quantification of the characteristic glycosidic residues obtained following acid hydrolysis, reductions, and derivatizations of the relevant fractions originating from said food product. The oligosaccharide content of the liquid food product, for its part, is determined by GC/MS analysis of the trimethylsilylated derivatives obtained by methanolysis of the oligosaccharides (Doco et al., 2001, Polymers, 46, 249-259). The oligosaccharide and polysaccharide contents may be expressed in mg of compounds per liter of liquid food product.

As is illustrated in the examples, the method of the invention greatly increases the rhamnogalacturonan-II (RGII) polysaccharide content. Thus, in certain embodiments, the method of the invention produces an RGII-enriched liquid food product: that is, one having a content that is at least equal to 1.2 times, preferably to 1.5 times, that of a reference liquid food product obtained by a method that is analogous to the method of the invention but that does not include the enzymatic maceration step (c).

In certain embodiments, as is shown in the examples, the method of the invention may enable the production of a liquid food product that has:
A polysaccharide content that is equal to at least 1.5 times that of the reference liquid food product,
An RGII content that is at least equal to 4 times that of the reference liquid food product, and
An oligosaccharide content that is at least equal to 2 times that of the reference liquid food product.

More specifically, the object of the invention is the creation of a method for preparing a liquid food product enriched with oligosaccharides and polysaccharides from berries, including the following successive steps:
(a) A step for heating the berries to a temperature ranging from 40° C. to 100° C.,
(b) A step for placing the berries in a vacuum at a pressure ranging from 10³ to 3.10⁴ Pa; said step for placing the berries in a vacuum is preferably performed immediately after step (a) is completed,
(c) A step for macerating the berries by seeding them with one or more pectolytic enzymes, and
(d) A final step for recovering the liquid food product.

By way of information, it should be noted that the combination of steps (a) and (b) corresponds to the abovementioned “flash release” step.

In the preferred embodiments of the method of the invention, steps (a), (b), and (c) of the method are performed prior to any step for pressing the berries: that is, any step during which the berries are mechanically pressed in order to extract their juice.

This pressing step is then performed after step (c) and before step (d); it eliminates solid residues such as the skins and seeds of the grape berries, in particular grape seeds, in order to collect liquid juice from the berries that is essentially free of solid particles, prior to any fermentation step, if winemaking is involved.

In step (a) of the method of the invention, the berries are heated to a temperature ranging from 40° C. to 100° C., preferably to a temperature ranging from 70° C. to 100° C., over a period lasting from several minutes to several tens of minutes.

A temperature ranging from 40° C. to 100° C. encompasses a temperature of 40, 45, 50, 55, 60, 65, 70, 75, 80, 82, 84, 86, 87, 88, 89, 90, 91, 92, 93, 94, 95, 96, 97, 98, 99, and 100° C. Temperatures on the order of 65 to 95° C. could, for example, be used.

More particularly, the berries are heated over a time period ranging from 1 to 30 minutes. In certain embodiments, the berries are brought up to the desired temperature over a time period of less than 15 minutes, which encompasses a duration of less than 14 minutes, less than 13 minutes, less than 12 minutes, less than 11 minutes, less than 10 minutes, less than 9 minutes, less than 8 minutes, less than 7 minutes, less than 6 minutes, less than 5 minutes, less than 4 minutes, and less than 3 minutes.

The berries may be heated using any method known to a person skilled in the art. In certain embodiments, the berries are heated using a technique selected from the group comprising (i) indirectly heating the berries using a heat exchanger, (ii) heating the berries by immersing them in a hot liquid, preferably a must, (iii) heating the berries using a vapor flux, (iv) ohmic-heating the berries, and (v) microwave-heating the berries.

The berries may be indirectly heated using any type of heat exchanger, such as a coaxial exchanger or a scraped-surface heat exchanger.

When the berries are heated by a vapor flux, said vapor flux may be obtained from juice or condensate originating from the berries and/or condensed vapors collected when the berries are placed in the vacuum in step (b). This type of heating enables rapid heating (generally from 1 to 15 minutes) of the berries to a given temperature in the absence of oxygen. Vapor-flux heating therefore enables rapid and controlled heating of the berries while limiting the development of oxidation reactions, which have a negative direct impact on the organoleptic properties of the final wines.

To implement the step for heating the berries, a person skilled in the art may refer to reference articles describing the various heating techniques suitable for heating the berries as part of preparing juice or wine, and more specifically, to the overview article by Escudier et al., (Revue francaise d'cenologie, 2008, 229, 9-18).

A person skilled in the art may also use one of the commercially available devices for heating the berries, more particularly the coaxial dynamic exchanger marketed by Pera and the “thermocompact unit” device marketed by Della Toffola.

In step (b) of the method of the invention, the heated berries are placed in a vacuum at a pressure ranging from 10³ to 3.10⁴ Pa. Placement of the berries in the vacuum is generally instantaneous; that is, its duration is several fractions of a second to several seconds at most. Placement of the berries in the vacuum causes partial evaporation of the water contained inside the berries, accompanied by a decrease in the temperature of the berries. The temperature obtained at the end of step (b) will be, e.g., below 70° C., specifically below or equal to 65° C., but generally above 28° C., specifically above or equal to 30° C.

The berries may be placed in the vacuum by a release chamber equipped with a vacuum pump and a condenser, which makes it possible to recover the vapor emitted by the berries as they are being placed in the vacuum.

In certain embodiments, step (a) of the method includes two successive steps:
A step for heating the berries to a temperature ranging from 40° C. to 100° C. and
A step for macerating the berries at the optimized temperature for enzymatic maceration by adjusting the vacuum level in order to perform moderate cooling of the harvested grapes, more particularly above or equal to 30° C. and below 70° C.

The step for macerating the berries is performed without substantial alcoholic fermentation of the berries and may be implemented inside the heating chamber itself. It generally involves a rapid maceration step lasting from 1 minute to 120 minutes, preferably from 1 minute to 60 minutes, which encompasses a maceration step lasting 60 minutes, 50 minutes, 40 minutes, 30 minutes, 25 minutes, 20 minutes, 15 minutes, 13 minutes, 11 minutes, 10 minutes, 9 minutes, 8 minutes, 7 minutes, 6 minutes, 5 minutes, 4 minutes, and 3 minutes. This thermal maceration step may improve the extraction of certain compounds of interest, such as anthocyanins and tannins. The step for heating the berries to a temperature ranging from 40° C. to 100° C. is generally performed in several minutes, preferably from 1 minute to 10 minutes.

Placement of the berries in the vacuum causes the berries to cool to a temperature suitable for implementing the enzymatic maceration step (c). In other words, upon completion of step (b), the berries have cooled to a temperature enabling the direct implementation of the enzymatic maceration step (c) without previously cooling or heating the berries. As will be further specified hereinafter, a temperature that is suitable for implementing the enzymatic maceration step (c) generally falls within a range of 20° C. to 65° C., specifically from 30° C. to 65° C.

The vapor emitted during step (b) may be condensed and reincorporated into the berries during any of the steps of the method, more particularly during steps (a) and (c) of the method of the invention, or into the final product obtained during step (d).

As is illustrated in the examples hereinafter, the Applicant has shown that the compounds responsible for grassy off-flavors detected in final juices and wines may be largely eliminated during step (b), which involves placing the berries in a vacuum. Indeed, pyrazine and the C6 compounds that cause off-flavors are mainly found in the condensed vapor from step (b). Hence, in order to improve the organoleptic qualities of the final food liquid, it may be advantageous to not reincorporate the condensed vapor collected in step (b) in the method of the invention. Therefore, in certain embodiments, the vapor emitted during step (b), when the berries are placed in a vacuum, is condensed and discharged.

The guidelines for the flash release method resulting from the combination of steps (a) and (b) are described in patent EP0728189. A person skilled in the art may therefore refer to the contents of patent EP0728189 as well as those of the overview article by Escudier et al., (Revue francaise d'cenologie, 2008, 229, 9-10) to implement steps (a) and (b) of the method. More particularly, steps (a) and (b) may be performed using the “flash release” installation marketed, e.g., by Pera or the Thermocooler® installation marketed by Della Toffola.

In the method of the invention, maceration step (c) involves seeding the berries obtained upon completion of step (b) with one or several pectolytic enzymes. By “seeding”, we mean adding a quantity of exogenic enzymes needed for preparation of the berries, specifically approximately 0.1 to 8 g of pectolytic enzymes per hectoliter of berries or per 100 kg of berries, specifically 2 to 4 g per hectoliter of berries. Step (c), involving enzymatic maceration of the berries, is hence generally performed prior to the alcoholic fermentation phase, under conditions that limit maceration, and preferably without alcoholic fermentation. This enzymatic maceration step using enzymes that are exogenous to those of the grapes is preferably performed before any pressing step: that is, for berries whose juice and solid matrix (skin, pulp, seeds, etc.) have not been separated by the action of a press or a decanter.

By “pectolytic enzymes”, also referred to as “pectinases”, we mean enzymes that are able to break down the pectins present in the cell walls of plants, and, more particularly, in the skin of grapes. The action of pectinases essentially consists of cleaving certain covalent bonds of pectin, which may lead to the release of glucoses, oligosaccharides, and/or lower-molecular-weight polysaccharides. Pectolytic enzymes include, but are not limited to, enzymes from the hydrolase class (EC 3) such as glycosyl hydrolases, endo- and exo-polygalacturonases, β-galactosidases, pectin esterases, and pectin methyl esterases, as well as enzymes from the lyase class (EC 4) such as pectin lyases.

Preferably, the pectolytic enzyme(s) is/are selected from the group composed of endo-polygalacturonases (EC 3.2.1.15), exo-polygalacturonases (EC 3.2.1.67), rhamnogalacturonases (EC not defined), β-galactosidases (EC 3.2.1.23), pectin esterases (EC 3.1.1.11), pectin methyl esterases (EC 3.1.1.11), and pectin lyases (EC 4.2.2).

It goes without saying that the pectolytic enzyme(s) introduced into the berries in order to implement enzymatic maceration step (c) is/are enzymes that are suitable for developing products intended for human consumption. In certain embodiments, the pectolytic enzyme(s) of step (c) are œnological enzymes: that is, enzymes listed in the International Oenological Codex. Preferably, the pectolytic enzymes are obtained from a species of Aspergillus such as A. niger or A. aculearus. The pectolytic enzymes of step (c) can be added in the form of a solid or liquid enzymatic preparation obtained from a species of Aspergillus such as Aspergillus niger. More specifically, these may be commercial enzymatic preparations suitable for use in winemaking. It should be noted that commercial enzymatic preparations are generally intended for clarifying juices and wines obtained after pressing (and therefore in the absence of grape skins).

This enzymatic preparation may include one or several enzymes that are not pectolytic enzymes. In other words, the enzymatic preparation includes a primary pectolytic activity that may, if desired, be combined with one or several secondary enzymatic activity/activities. Secondary enzymatic activities participate, preferably, in cell wall lysis, and encompass, but are not limited to, cellulase, hemicellulase, mannosidase, glucosidase, rhamnosidase, arabinanase, and arabinosidase activities.

Thus, in certain embodiments of the method of the invention, in step (c) of the method, the berries obtained upon completion of step (b) are seeded with an enzymatic preparation that has a pectolytic primary activity and one or several secondary activities selected from the group composed of cellulase, hemicellulase, glucosidase, and arabinosidase activities.

Thanks to his/her experience and general knowledge, a person skilled in the art will know how to determine the optimal conditions for implementing maceration step (c), more particularly, as regards the quantities of enzymes to be used, the maceration temperature and duration of step (c). Generally speaking, for a commercial enzymatic preparation, the quantity to be added falls within a range of 2 to 8 g of commercial enzymatic preparation per hectoliter of berries, specifically 2 to 4 g per hectoliter of berries. This brings into contact quantities of enzymes that generally correspond to 1000 to 10000 pectinase units per 100 kg of berries, specifically from 1500 to 3500 units.

Maceration step (c) is carried out at a temperature suitable for the use of pectolytic enzymes. The optimal temperature for implementing enzymatic maceration varies depending upon pectolytic enzyme(s) used, and will be adjusted by a person skilled in the art based upon the type of enzymes used and their thermoresistance. Nevertheless, the maceration temperature is generally lower than 65° C., preferably ranging from 20° C. to 65° C., preferably above 28° C. and specifically from 30 to 65° C. Advantageously, the enzymatic maceration temperature falls within a range from 30° C. to 55° C., preferably falling within a range from 40° C. to 55° C., more specifically from 45 to 55° C. The enzymatic maceration step will be, e.g., performed at a temperature of 50° C., a temperature that is incompatible with an alcoholic fermentation process. The duration of maceration generally ranges from 10 minutes to 10 hours. Preferably, the duration of maceration step (c) falls within a range of 2 hours to 8 hours, which encompasses a reaction duration of 2 hours, 3 hours, 4 hours, 5 hours, 6 hours, 7 hours, and 8 hours.

In a preferred embodiment, maceration step (c) is performed at a temperature ranging from 30° C. to 55° C. for a duration from 2 hours to 8 hours.

During maceration step (c), various technological options exist for performing the maceration step, and more particularly for improving the enzyme/skin contact effect: introducing enzymes into the vacuum tank at the required temperature, and implementing maceration inside a tank while stirring. It is also possible to perform the maceration inside the chamber of the press, which is transformed into a maceration tank in this case.

In certain embodiments, the method of the invention may include one or several steps in addition to steps (a), (b), (c), and (d).

Preferably, step (a), for heating the berries, may be preceded by a step for destemming and/or draining the berries. The drained-off juice may be reincorporated as the method proceeds.

Step (c) of the method may be followed by a step for pressing the berries; the pressing step produces the final liquid food product. In this embodiment, maceration step (c) may be performed inside the pressing chamber before pressing of the berries has begun. In other words, enzymatic maceration step (c) may be performed while the pressing chamber is being filled and before pressing as such has begun. This type of embodiment is especially advantageous because it avoids the use of a maceration tank for the specific implementation of step (c) and pumping the berries from said maceration tank toward the pressing chamber. It may also save time because the maceration step is performed concomitantly with the filling of the pressing chamber. Pressing is preferably performed at the temperature of step (c)—that is, while hot, at a temperature ranging from 20° C. to 65° C. To implement this specific embodiment, a person skilled in the art may use a press, any type of press commonly used in winemaking: specifically, a pneumatic press—or alternatively, a centrifuge decanter—on the harvested grapes.

Once pressing is completed, an additional step for clarifying the juice obtained may be performed in order to lower its turbidity. This clarification step may be performed by centrifugation, decantation, filtration, or enzyming: that is, by seeding the pressed juice with clarification enzymes.

Other additional steps may be implemented in the method of the invention, such as pasteurization and/or fermentation steps; these steps are implemented after enzymatic maceration step (c).

Finally, the method of the invention may be implemented continuously or discontinuously. The raw material processed by the method of the invention may consist of whole berries or destemmed and/or drained and/or partially or entirely crushed berries.

In a specific embodiment, the method of the invention includes the following successive steps:
A preliminary step for destemming and/or draining and/or totally or partially crushing the berries, preferably grape berries,
A step for heating (a) the berries to a temperature ranging from 40° C. to 100° C., preferably from 70° C. to 100° C., over a time period from 1 minute to 120 minutes, preferably from 1 minute to 60 minutes, said heating of the berries being performed by (i) indirectly heating the berries using a heat exchanger, (ii) heating the berries by immersing them in a hot liquid, preferably a must, (iii) heating the berries with a vapor flux, (iv) ohmic heating of the berries, or (v) microwave-heating the berries,
A step for placing the berries in a vacuum (b) at a pressure ranging from 10³ to 3.10⁴ Pa, said step for placing the berries in a vacuum being performed directly upon the completion of step (a), enabling the berries to cool to a temperature that is suitable for the direct implementation of a subsequent maceration step by seeding them with an enzymatic preparation obtained from an Aspergillus strain and that has a pectolytic primary activity selected from the group composed of endo-polygalacturonases, exo-polygalacturonases, β-galactosidases, pectin esterases, rhamnogalacturonases, pectin methylesterases, and pectin lyases, and wherein the vapor produced by placing the berries in a vacuum is condensed and discharged,
A step (c) for macerating the berries from step (b) by seeding the berries with an enzymatic preparation with pectolytic primary activity obtained from a strain of Aspergillus; said maceration step is performed for a duration of 10 minutes to 10 hours, preferably from 2 hours to 8 hours, and at a temperature ranging from 20° C. to 65° C., preferably from 30° C. to 55° C., and
A final step (d) for recovering the liquid food product including the pressing of the berries obtained from step (c).

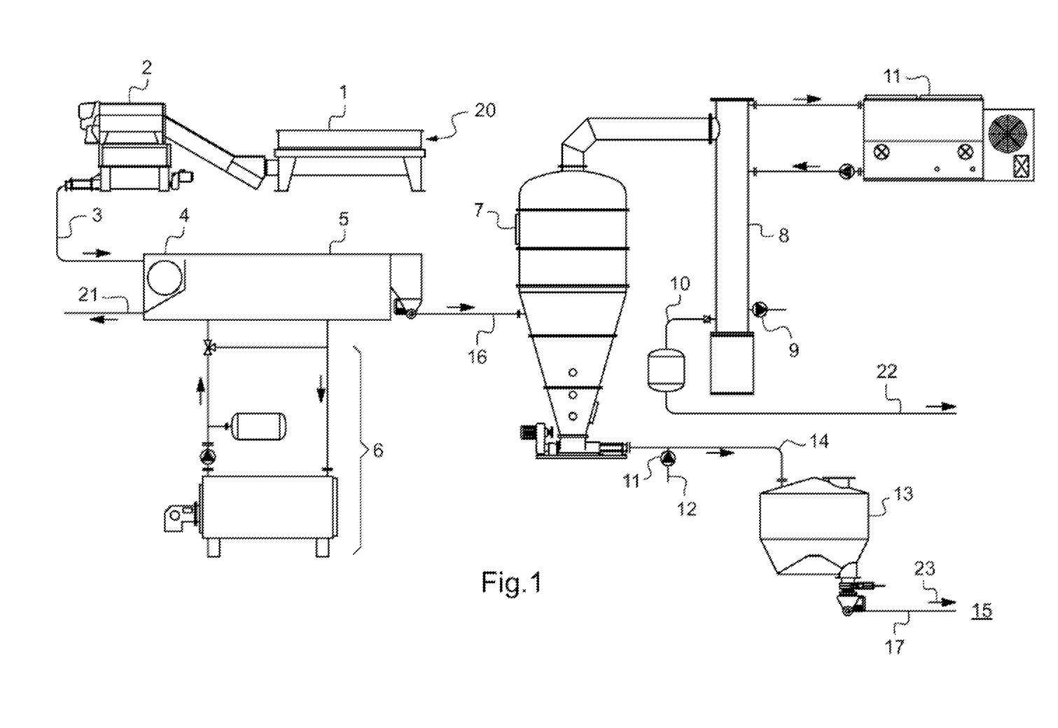

As has been specified previously, a person skilled in the art has at his/her disposal several commercial installations for implementing the flash release method. A person skilled in the art, through his/her general knowledge and thanks to the commercial devices at his/her disposal, will easily be able to design an installation suitable for implementing the method of the invention. For example, a person skilled in the art will be able to adapt the installation disclosed in FIG. 1 of patent EP0728189 by connecting a maceration chamber, which is itself connected to a press, to the release chamber.

In an alternative embodiment, a person skilled in the art may use an installation that has the elements disclosed in FIG. 1. In the installation disclosed in FIG. 1, the harvested grapes—that is, the berries (20)—are collected in a suitable device (1), and then are moved first into a destemmer (2), and next into a drainer (4), by a suitable means (3). The drained-off juice (21) is collected by a suitable means. This drained-off juice may be eliminated, added to the final juice, or used to generate the vapor needed for heating the harvested grapes (1) inside the heating chamber. If the harvested grapes (20) are unclean, the drained-off water (21) is preferably eliminated, and is therefore not used during the method. The drained harvested grapes travel inside the heating chamber (5), where they are brought to a suitable temperature that generally ranges from 70° C. to 100° C. The heating chamber (5) may be of any type. It may be a chamber for heating the harvested grapes that immerses them in a juice or a must. It may also be a coaxial or scraped-surface exchanger, or an ohmic or microwave heating unit. Heating of the harvested grapes (20) may be performed by formed biological condensing vapor, e.g., from drained-off juice or from condensate originating from the method. Upon exiting the heating chamber (5), the harvested grapes (1), heated to a temperature ranging from 70° C. to 100° C., is brought through a suitable pipe (16) into the release chamber (5 [sic]). The release chamber (7) is connected to a condenser (8), which in turn is connected to a vacuum pump (9) that is able to create a vacuum from 10³ to 3.10⁴ Pa inside the release chamber (6 [sic]). The condenser (8) is also connected to a cooling tower. Placement of the berries in the vacuum inside the release chamber (7) causes partial evaporation of water from the berries and cools them to a temperature that is suitable for the subsequent maceration step involving pectolytic enzymes (12). At its outlet, the condenser (8) has an appropriate means (10) for collecting the condensed vapor (22) originating from the placement of the heated harvested grapes (1) in the vacuum. In the embodiment shown here, the condensed vapor (22) is not reincorporated into the method.

Upon exiting the release chamber (7), the harvested grapes are conveyed through a suitable pipe (14) into a maceration tank (10). The enzymatic preparation with pectolytic activity (12) is added upstream of the maceration tank (10) to the berries in the pipe by means of an injection valve (11). The maceration tank (10) may include a suitable means for maintaining the maceration temperature at a desired value. The maceration tank may also have a filling level that may be adjusted based on the duration of maceration, and may be equipped with means for stirring the harvested grapes during maceration. Maceration is of variable duration, as was mentioned previously, generally lasting several minutes to several hours. When maceration is completed, the processed berries (23) are conveyed through a suitable pipe (17) into a press (11) that may be of any type, including mechanical, pneumatic, or dynamic. The juice created by pressing the harvested grapes is recovered at the outlet of the press (11) either for packaging must or juice, or for use in a vinification step.

The method of the invention makes it possible to produce liquid food products from berries, wherein said liquid food products are enriched with polysaccharides and oligosaccharides. The liquid food product obtained upon completion of step (d) as described previously is therefore a berry juice, essentially free of solid residue, and does not have a significant alcohol content: preferably an alcohol content below 0.5% by volume, even less than or equal to 0.2% by volume; the fermentation process occurs on clarified must. The polysaccharide content—more particularly, the RGII polysaccharide content—detected in the liquid food product of the invention is much higher than that observed in liquid food products produced using extraction methods such as crushing, thermal processing such as hot prefermentation maceration, or the liquid-phase flash-release method, in the absence of a specific step for pre-pressing maceration of the berries using one or several pectolytic enzymes.

The present invention therefore also relates to the use of the maceration of berries by seeding them with one or several enzymes with pectolytic activity in a method for preparing a liquid food product from berries in order to enrich the liquid food product with polysaccharides and oligosaccharides. This enzymatic maceration of the berries will be performed prior to any alcoholic fermentation step using traditional techniques that implement yeasts.

Optionally, the liquid food product recovered upon completion of step (d) may undergo a step for inactivating the pectolytic enzymes, e.g., via flash pasteurization processing (for reference purposes, 90° C. for several minutes).

Additionally, the method of the invention may include optional steps for liquid-medium alcoholic fermentation of the polysaccharide-enriched liquid food product directly following step (d), or after supplemental clarification and/or enzymatic inactivation steps. The product obtained following alcoholic fermentation is a wine that includes increased levels of polysaccharides and RGII.

Preferably, maceration of the berries by seeding them with one or several enzymes with pectolytic activity is performed prior to any step for pressing the berries, and is coupled with a step for placing the berries in a vacuum.

The invention also relates to a liquid food product that may be obtained by the method of the invention, and that offers the previously described properties. More specifically, an additional object of the invention is the creation of a liquid food product prepared from berries characterized in that it includes:
An oligosaccharide content that is at least equal to 1.2 times, preferably to 1.5 times, that of a reference product, and
A polysaccharide content that is at least equal to 1.2 times, preferably to 1.5 times, that of a reference product, made of an equivalent raw material

With said reference product being obtained by a method that is similar to the method implemented in order to obtain the liquid food product, but that does not include enzymatic maceration step (c).

As was previously stated, the liquid food product obtained by the method of the invention is particularly well suited for use in the preparation of polysaccharide- and oligosaccharide-enriched wines, more particularly red wines, by liquid-phase vinification.

An additional object of the invention is the creation of a method for preparing a wine including a liquid-phase vinification step—with alcoholic fermentation—of the liquid food product obtained by the method of the invention.

More specifically, the object of the invention is the creation of a method for preparing a polysaccharide- and oligosaccharide-enriched wine, preferably a red wine, including the following successive steps:
(a) A step for heating the berries to a temperature ranging from 40° C. to 100° C. over a time period ranging from 1 minute to 120 minutes, preferably from 1 minute to 60 minutes,
(b) A step for placing the berries in a vacuum at a pressure ranging from 10³ to 3.10⁴ Pa; said step for placement of the berries in the vacuum is performed immediately upon completion of step (a),
(c) A step for macerating the berries by seeding them with one or several enzymes with pectolytic activity,
(d) A step for pressing the macerated berries obtained in step (c) in order to obtain a liquid food product; this step may optionally include the elimination of the residual solid particles that are present in the liquid food product obtained after pressing, and
(e) A step for liquid-phase vinification of the liquid food product obtained in step (d).

In the context of the present invention, by “liquid-phase vinification”, we mean the alcoholic fermentation of the liquid product produced in step (d). In other words, the liquid-phase alcoholic fermentation occurs in the absence of marc (and therefore in the absence of grape skins), and may be assisted by adding commercially available œnological yeasts or malolactic cultures. This liquid-phase vinification step is generally performed at a regulated temperature (generally between 20 and 25° C.) after adding yeast and adding a small amount of sulfites, and lasts from one to several days.

Therefore, the method of the invention may be used to prepare red wines by liquid-phase fermentation. This is particularly surprising when one considers that the prior art discloses that red wines with a good organoleptic profile are very generally obtained by vinification on marc. The red wines thereby obtained are vinified in the liquid phase, as are white wines.

Steps (a), (b), and (c) are like those previously described in the context of the method for preparing a liquid food product. The various embodiments of these previously described steps may therefore be implemented, alone or in combination, in the method for preparing a wine according to the invention.

It should be noted that the wine preparation method as previously described may include supplemental steps. More particularly, step (a) may be preceded by a step for destemming and/or draining and/or partially or totally crushing the grape berries.

A supplemental goal of the invention is a wine, preferably a red wine that may be obtained according to the previously described wine preparation method.

Regarding the experimental results obtained for the grape juices, it is anticipated that the wine of the invention will have oligosaccharide and polysaccharide content levels that are at least 1.2 times, and preferably at least 1.5 times, higher than the oligosaccharide and polysaccharide content levels of a wine obtained from a reference liquid food product as defined previously.

The present invention is also illustrated by, but is in no way limited to, the following examples.

### Example 1

### The Effect of Combining a Flash Release Step and a Maceration Step Involving Pectolytic Enzymes on Grape Juice Composition

1. Materials and Methods

a) Harvested Grapes

The experiments were conducted with a Teinturier grape variety: Alicante from Domaine INRA Pech Rouge. The grapes were mechanically harvested using a Pellenc machine equipped with an on-board destemmer and sorting table (Selectiv System). The stems, petioles, and leaf fragments are therefore eliminated at the harvesting stage. The yield of the parcel was 6.1 tons per hectare.

b) Enzymatic Preparations with Pectolytic Activity

Two commercially available enzymatic preparations obtained from Aspergillus niger were used: Enzyme 1 and Enzyme 2.

The quantities added for implementing the pre-pressing enzymatic maceration step are those recommended by the manufacturer.

c) Method Implementing the Flash Release Technology

The harvested grapes are processed by flash release using a device that connects a heat exchanger with biological vapor flux to a release chamber.

The harvested grapes were heated to 95° C. in 9 minutes, and then placed in a vacuum of 100 mbars absolute. The placement of the harvested grapes in the vacuum lowered their temperature to 45° C.

Immediately upon exiting the release chamber, three batches of 100 kg of harvested grapes were sampled. Two batches were seeded with an enzymatic preparation with pectolytic primary activity (Enzyme 1 or Enzyme 2). Enzymatic maceration of the harvested grapes was performed at 45° C. for 3 hours while stirring in a tank whose volume was adjusted so as to enable this contact time. Following the maceration step, the harvested grapes were pressed with a pneumatic water press at a pressure of 3 bars for 10 minutes. The harvested juice underwent an enzymatic clarification step overnight at 10° C. Following homogenization and centrifugation (8000 rpm/min for 5 minutes), the juice was packaged in 25-cl bottles, pasteurized at 85° C. for 20 minutes in an autoclave by vapor flux, cooled quickly under running water, and then stored in a wine cellar at 17° C.

The third batch of harvested grapes set aside upon exiting the release chamber (control batch) underwent processing similar to the other two batches except for the enzymatic maceration step following the flash release, which was replaced by a step in which the harvested grapes were incubated for 3 hours at 45° C.

d) Thermal Processing Method (Comparative)

In this juice preparation method, the flash release step was replaced by a thermal processing step that consisted of heating the harvested grapes using a screw heat exchanger to a temperature of 75° C. by biological vapor flux (produced by a fraction of the juice); the speed of the heating chamber's worm gear was set in order to have the temperature rise continuously from 25° C. to 75° C. in 2 minutes.

When thermal equilibrium was reached, four batches of 100 kg of harvested grapes were sampled and drained in 200-L containers.

The first batch underwent maceration in the absence of enzymes for 40 minutes at 75° C., and was pressed directly with a pneumatic water press at a pressure of 3 bars for 10 minutes.

The three other batches were cooled to 60° C. (after approximately 2 hours). Two of them were seeded using an enzymatic preparation with pectolytic activity (Enzyme 1 or Enzyme 2) and underwent hot pre-fermentation maceration at 60° C. for 6 hours. The final batch was allowed to macerate at 60° C. without enzymes. These three batches were pressed directly with the pneumatic water press at a pressure of 3 bars for 10 minutes.

The four batches of juice obtained after pressing underwent enzymatic clarification overnight at 10° C. Following homogenization and centrifugation (8000 rpm/min for 5 minutes), the juice was packaged in 25-cl bottles, pasteurized at 85° C. for 20 minutes, and then stored in a wine cellar at 17° C.

When the objective is to formulate a red wine and not a juice, the obtained juice may be fermented at a regulated temperature (generally from 20 to 25° C.) after adding yeast and sulfites.

e) Analysis of Juices

The obtained juices are analyzed on the first day:
°Brix
pH
Total acidity, potentiometric titration (g H₂SO₄/L)
Color intensity (CI): the sum of absorbances at 420, 520, and 620 nm, spectrophotometry (“Foulon SOPAGLY” Method=dilution with buffer at juice's pH), diluted Alicante juice 1/10 3.5-pH buffer solution, diluted Carignan juice 1/5 3.10-pH buffer solution, measurement of absorbances at 420, 520, and 620 nm in a 1-mm tank
Anthocyanin content, spectrophotometry (mg or g/L), AUBERT Method: 1/100 dilution with 96% acidified ethanol, 2% HCl, measurement of absorbance at 550 nm in a 10-mm tank
Total Polyphenol Index (TPI), spectrophotometry, 1/100 dilution with water, measurement of absorbance at 280 nm in a 10-mm tank
L * a * b, spectrocolorimetry, Minolta

In order to monitor changes in the samples over time, the CI, the TPIs, and the anthocyanin content were then analyzed every day for one week, then every fifteen days for three months, and finally every other month for one year.

f) Analysis of the Oligosaccharide and Polysaccharide Content of the Juices after Bottling
Preparation of Polysaccharides and Oligosaccharides from the Juices:
5 mL of juice is sampled directly from the bottle and bleached on a Polyamide SC6 gel column equilibrated with 1M NaCl. The unused fraction is concentrated, then injected onto a permeation gel column (Superdex 30; 1.6×60 cm, Amersham Biosciences) equilibrated with 30 mM ammonium formiate, pH 5.8, at a flow rate of 1 mL/min
Characterization:
The polysaccharide fraction is collected and analyzed in terms of its monosaccharide composition obtained after acid hydrolysis, reduction, and acetylation of the released monomers (1 mg sample, TFA 2N, 75 minutes, 120° C., reduction (NaBH₄, 20 mg/mL at pH 11), acetylation and analysis of the acetylated polyols using GC/MS (gas chromatography combined with a mass spectrometer). The oligosaccharide fraction is collected and analyzed via GC/MS analysis of the trimethylsilylated (TMS) derivatives formed following methanolysis (MeOH/HCl 1N, 16H, 80° C.).

2. Results

a) Color Intensity, Total Polyphenol Index, and Anthocyanin Content.

The best results in terms of color intensity, total polyphenol index, and anthocyanin content were obtained for the grape juices prepared using the methods that implemented flash release technology. Strikingly, the juices obtained by implementing flash release technology have a color intensity and an anthocyanin content that are approximately 30% higher than those found in juices obtained by thermal processing.

Implementation of a pre-pressing maceration step using pectolytic enzymes has no impact on the juices' polyphenol content or color intensity.

In other words, maceration using a pectolytic enzymatic preparation that is performed prior to the pressing step has no impact on polyphenol extraction, regardless of whether this maceration step is combined with a flash release step or with a step for thermal processing of the harvested grapes.

TABLE 1
Color intensity, total polyphenol index, and anthocyanin content of grape juices
after 282 days of storage according to preparation method

| | Color | Total Polyphenol Index | Anthocyanin |
|---|---|---|---|
| | Intensity | (measured at 280 nm) | Content (g/L) |
| Flash release + pre-pressing maceration | 34.6-35 | 129-141.2 | 1.23-1.25 |
| (invention) batch | | | |
| Flash release without enzymatic maceration | 34.3 | 138.1 | 1.24 |
| batch | | | |
| Thermal processing + pre-pressing | 25.2-27.1 | 115.7-119.5 | 0.91-0.98 |
| enzymatic maceration batches | | | |
| Thermal processing without pre-pressing | 25.2-26.8 | 128.1 | 0.89 |
| enzymatic maceration batches | | | |
| Thermal processing with 40 min at 75° C. | 29.9 | 128.8 | 1.09 |
| without enzymatic maceration batches | | | |

b) Polysaccharide and Oligosaccharide Concentration in the Grape Juices

The polysaccharide composition of each juice is calculated based on the concentration of the various glycosidic residues determined by GC and that are characteristic of polysaccharides isolated from wine (Vidal et al., 2003, Carbohydrate Polymers, 54(4), 439-447). The concentrations are expressed in mg/liter of juice.

The preponderant polysaccharides are AGRPs, or arabinose- and galatose-rich polysaccharides. They represent 60% to 80% of the polysaccharides isolated in the juices. The second class of detected polysaccharide is rhamnogalacturonan II. Very low levels of polymannans are detected.

Flash release makes it possible to extract two times more polysaccharides than the reference thermal processing does, whether the pre-pressing maceration step using pectolytic enzymes is implemented or not.

It is worth highlighting the fact that combining the flash release method with maceration of the berries using pectolytic enzymes very significantly increases the polysaccharide content in the juices, as compared to a flash release method that does not implement said maceration step. In the content of a preparation method based on flash release technology, the enzymatic maceration step increases the overall polysaccharide content by approximately 175%: thus, the total polysaccharide content rises from 390 mg/L (flash release method without enzymatic maceration) to 690 mg/L (flash release method followed immediately by maceration of the berries using pectolytic enzymes). The polysaccharide that benefits the most from this increase is the RGII polysaccharide, which rises from 50 mg/L to 300 mg/L.

Combining thermal processing with an enzymatic maceration step also leads to an increase in the polysaccharide content of the juices (as compared to the juices obtained by thermal processing without implementing a pre-pressing enzymatic maceration step). Nevertheless, the increase in the polysaccharide content of the juices is much smaller than that observed for juices obtained by flash release: indeed, the polysaccharide content rises from, at most, 210 mg/L to 360 mg/L, and the RGII content rises from, at most, 40 mg/L to 130 mg/L.

In other words, the differences in the observed polysaccharide content among the juices obtained by flash release (flash release+pre-pressing pectolytic enzymatic maceration) are much greater than those observed for the juices obtained by thermal processing and by thermal processing+pre-pressing pectolytic enzymatic maceration.

We thereby observe that (i) the flash release step and (ii) the pre-pressing maceration step involving pectolytic enzymes act synergistically on the extraction of polysaccharides. This synergistic effect is not observed when the thermal processing step is combined with a pre-pressing maceration step involving pectolytic enzymes.

TABLE 2
Total polysaccharide content (AGRPs, RGII, and MPs) and content of
RGII alone in the juices obtained for the various methods.

| | | RGII |
|---|---|---|
| | Polysaccharide | Content |
| | Content (mg/L) | (mg/L) |
| Flash release + pre-pressing enzymatic | 690 | 250 |
| maceration batch | | |
| Enzyme 1 (invention) | | |
| Flash release + pre-pressing enzymatic | 720 | 300 |
| maceration batch | | |
| Enzyme 2 (invention) | | |
| Flash release without enzymatic maceration | 390 | 50 |
| batch (comparative) | | |
| Thermal processing + pre-pressing | 240 | 90 |
| enzymatic maceration batch | | |
| Enzyme 1 (comparative) | | |
| Thermal processing + pre-pressing | 360 | 130 |
| enzymatic maceration batch | | |
| Enzyme 2 (comparative) | | |
| Thermal processing without pre-pressing | 210 | 40 |
| enzymatic maceration batch (comparative) | | |
| Thermal processing with 40 minutes at 75° C. | 180 | 40 |
| without enzymatic maceration (comparative) | | |

An identical tendency is observed for the oligosaccharide content of the final juices, as is illustrated in Table 3 below.

Indeed, introducing a pre-pressing enzymatic maceration step significantly increases the oligosaccharide content both in the juices obtained by flash release (from +230% to +325%) and in the juices obtained by thermal processing (from +165% to +218%). Nevertheless, the increase is much greater in the case of juices obtained by flash release than for juices obtained by thermal processing, which again illustrates the synergistic effect resulting from combining the pre-pressing enzymatic maceration step with the flash release step of the method of the invention.

Strikingly, the introduction of the pre-pressing enzymatic maceration step into the grape juice preparation method does not change the composition of the extracted oligosaccharides. The oligosaccharides that are present in the juices essentially include the following glucoses: rhamnose, arabinose, galactose, xylose, but also glucuronic and galacturonic acids. We therefore find arabinogalactan-, Type 1 rhamnogalacturonan-, and oligomannan-type oligosaccharides in the prepared juices. The identification of xylose and of 4-O-Me-glucuronic acid indicates the presence of glucuronoxylan-type hemicellulose traces resulting from the secondary activities of the enzymatic preparations used.

TABLE 3
Oligosaccharide content of the juices obtained for the various methods.

| | Oligosaccharide |
|---|---|
| | Content (mg/L) |
| Flash release + pre-pressing enzymatic | 924 |
| maceration batch | |
| Enzyme 1 (invention) | |
| Flash release + pre-pressing enzymatic | 656 |
| maceration batch | |
| Enzyme 2 (invention) | |
| Flash release without enzymatic maceration | 284 |
| batch (comparative) | |
| Thermal processing + pre-pressing enzymatic | 361 |
| maceration batch | |
| Enzyme 1 (comparative) | |
| Thermal processing + pre-pressing enzymatic | 479 |
| maceration batch | |
| Enzyme 2 (comparative) | |
| Thermal processing without pre-pressing | 219 |
| enzymatic maceration batch (comparative) | |
| Thermal processing with 40 minutes at 75° C. | 135 |
| without enzymatic maceration batch | |
| (comparative) | |

### Conclusion

Thermal processing of harvested grapes is effective for formulating colored grape juices. Flash release is the most effective technique for obtaining juices having improved properties in terms of color intensity, total polyphenol index, and anthocyanin content.

Combining flash release with a pre-pressing maceration stage involving pectolytic enzymes enables the production of polysaccharide- and oligosaccharide-enriched juices. The juices obtained by this combination include content levels of approximately 700 mg/L for polysaccharides and approximately 900 mg/L for oligosaccharides. Strikingly, the RGII content of the obtained juices is very high (up to 300 mg/L) as compared to the juices obtained by flash release (in the absence of a pre-enzymatic maceration step).

### Example 2

### Elimination of Grassy Notes

Eliminating vapor condensates emitted by the berries during vacuum step (b) of the method of the invention significantly decreases grassy off-flavors in the final wines. Indeed, while the vacuum step is being implemented, the aromatic compounds (C6 and pyrazine) that are responsible for grassy notes are extracted by vaporization, leading to a significant decrease in the content of these compounds in the berries.

TABLE 4
Overall content of C6 aromatic compounds (μg/L) in the berries after
and before implementing a flash release step
Overall Content of C6 Compounds (μg/L)

| | Content in | Content in Berries | |
|---|---|---|---|
| | Berries before | Immediately after Flash | |
| | Implementing Flash | Release (Elimination of | Loss |
| Grape Variety | Release Step | Condensates) | % |
| Cabernet | 622 | 346 | 44 |
| Sauvignon | | | |
| Merlot No. 1 | 141 | 73 | 48 |
| Malbec No. 1 | 782 | 640 | 18 |
| Merlot No. 2 | 262 | 111 | 58 |
| Carmenere 15/05 | 1442 | 208 | 86 |
| Merlot/ | 378 | 135 | 64 |
| Carmenere | | | |
| Malbec No. 2 | 894 | 143 | 84 |

TABLE 5
Pyrazine content in the berries and condensates formed during the flash
release method

| | Pyrazine Content (μg/L) | | | |
|---|---|---|---|---|
| | | Berries Immediately | Berries Immediately | |
| | Berries before | after Flash Release | after Flash Release | |
| | Implementing Flash | (Elimination of | with Reincorporation | Content in |
| Grape Variety | Release | Condensates) | of Condensates | Condensates |
| Cabernet Sauvignon | 5.2 | 1.7 | 3.7 | 24.6 |

1. A method for preparing a liquid food product enriched with oligosaccharides and polysaccharides from berries, including the following successive steps:
(a) heating the berries to a temperature ranging from 40° C. to 100° C.,
(b) placing the berries in a vacuum at a pressure ranging from 10³ to 3.10⁴ Pa; wherein placing the berries in the vacuum is performed immediately upon the completion of step (a),
(c) macerating the berries by seeding them with one or several pectolytic enzymes at a temperature from 30° C. to 65° C., and
(d) recovering the liquid food product.

2. A method according to claim 1, wherein steps (a), (b), and (c) are performed prior to any pressing and alcoholic fermentation of the berries.

3. A method according to claim 1, wherein, in step (a), the berries are heated for a duration ranging from 1 minute to 30 minutes.

4. A method according to claim 1, wherein, in step (a), the berries are heated using a technique selected from the group consisting of comprising (i) indirectly heating the berries using a heat exchanger, (ii) heating the berries by immersing them in a hot liquid, (iii) heating the berries using a vapor flux, (iv) ohmic-heating the berries, and (v) microwave-heating the berries.

5. A method according to claim 1, wherein, in step (b), in which the berries are placed in a vacuum, and then the berries are cooled to an appropriate temperature for implementing enzymatic maceration step (c).

6. A method according to claim 1, wherein, in maceration step (c), the pectolytic enzyme(s) is/are added to the berries in the form of an enzymatic preparation with pectolytic primary activity obtained from a species of Aspergillus.

7. A method according to claim 1, wherein the pectolytic enzyme(s) is/are selected from the group consisting of endo-polygalacturonases, exo-polygalacturonases, rhamnogalacturonases, β-galactosidases, pectin esterases, pectin methyl esterases, and pectin lyases.

8. A method according to claim 1, wherein maceration step (c) is performed at a temperature below 65° C. and above 30° C. over a time period of 10 minutes to 10 hours, in the absence of significant alcoholic fermentation.

9. A method according to claim 1, wherein vapors emitted by the berries during step (b) are condensed and reincorporated into the berries during any of the steps of the method.

10. A method according to claim 1, wherein the vapors emitted by the berries during step (b) are condensed and discharged.

11. A method according to claim 1, wherein the berries are first destemmed and/or drained and/or partially or entirely crushed before heating step (a) is implemented.

12. A method according to claim 1, wherein maceration step (c) is followed by a step for pressing the berries.

13. A method according to claim 12, wherein maceration step (c) is performed in the pressing chamber before pressing begins.

14. A method according to claim 1, wherein the berries are grape berries.

15. A liquid food product enriched with polysaccharides and oligosaccharides obtained from berries using the preparation method as defined in claim 1, including:
An oligosaccharide content level that is at least equal to 1.2 times that of a reference product, and
A polysaccharide content level that is at least equal to 1.2 times that of a reference product,
with said reference product being obtained by a method that is similar to the method implemented to obtain the liquid food product, but that does not include enzymatic maceration step (c).

16. A method for preparing a wine, which includes a liquid-phase vinification step of a liquid food product prepared according to the method defined in claim 1.

17. The method for preparing a wine of claim 16, wherein the liquid food product includes:
An oligosaccharide content level that is at least equal to 1.2 times that of a reference product, and
A polysaccharide content level that is at least equal to 1.2 times, that of a reference product,
with said reference product being obtained by a method that is similar to the method implemented to obtain the liquid food product, but that does not include enzymatic maceration step (c).

18. The method for preparing a wine of claim 16, wherein the wine is a red wine.

19. A method according to claim 1, wherein, in step (a), the berries are heated by immersing them in a must.

20. A method according to claim 15, wherein the oligosaccharide content level is at least equal to 1.5 times that of the reference product and the polysaccharide content level is at least equal to 1.5 times that of the reference product.
